(19) United States
(12) Patent Application Publication
(10) Pub. No.: US 2026/0202197 A1
(43) Pub. Date: Jul. 16, 2026

(54) ANGLE INDICATOR

(71) Applicant: OK Safety Partners Inc., Vernon (CA)

(72) Inventor: Kevin Roy Waldal, Vernon (CA)

(21) Appl. No.: 19/025,609

(22) Filed: Jan. 16, 2025

(51) Int. Cl. G01C 9/20

(52) U.S. Cl. CPC G01C 9/20

(57) ABSTRACT

An apparatus and method for indicating an angle of an article to a user. The apparatus comprises a casing having a mounting surface adapted to be securable to an article, the casing having a cavity therein defining a cavity volume, the cavity having an axis extending normal to the mounting surface, a quantity of a fluid selected to have a volume equal to substantially 50 percent of the cavity volume contained within the cavity and at least one angle indicator applied to an exterior surface of the casing around the cavity, at a position selected to align with a free surface of the fluid when the article is arranged at a desired angle, the at least one angle indicator arranged annularly around the axis. The method includes securing the apparatus to the article and orienting the article to a desired angle such that the one angle indicator is aligned with a free surface of the fluid.

### BACKGROUND

### 1. Technical Field

This disclosure relates generally to safe ladder use and in particular to a method and apparatus for indicating to a user the proper angle for a ladder.

### 2. Description of Related Art

Many articles are required to be oriented at particular angles. In particular, ladders, including extension ladders, are required to be set at an angle which will prevent both the bottom feet from slipping away from a wall or other vertical surface or tipping backwards under the weight of an occupant. A commonly accepted angle for inclination from horizontal is 75 degrees, also known as the 4 to 1 rule in which for every 4 feet up the vertical surface on which the ladder rests, the base should be 1 foot away from that surface.

It is known that many accidents happen due to incorrect placement and angular orientation of ladders. Such accidents may be either the base of the ladder slipping away from the wall causing the occupant to fall down or the ladder tipping away from the wall causing the occupant to tip backwards with it.

Conventional methods of ensuring proper ladder placement using the 4 to 1 rule require the operator to measure both the vertical and horizontal distances of the base and top of the ladder from and up the wall. Such measuring is time consuming, often resulting in an operator not performing such measurements.

### SUMMARY OF THE DISCLOSURE

According to a first embodiment of the present disclosure is an apparatus for indicating an angle of an article to a user. The apparatus comprise a casing having a mounting surface adapted to be securable to an article, the casing having a cavity therein defining a cavity volume, the cavity having an axis extending normal to the mounting surface, a quantity of a fluid selected to have a volume equal to substantially 50 percent of the cavity volume contained within the cavity and at least one angle indicator applied to an exterior surface of the casing around the cavity, at a position selected to align with a free surface of the fluid when the article is arranged at a desired angle, the at least one angle indicator arranged annularly around the axis.

The casing may include a perimeter surface therearound perpendicular to the mounting surface. The perimeter surface may include at least one indexing surface. The indexing surface may be selected to be one of parallel to or perpendicular to at least one horizontal indicator on the casing.

The at least one angle indicator may be arranged in matched pairs on opposite sides of the axis of the cavity. The at least one angle may include at least one horizontal indicator arranged at an angle adapted to correspond to one of a horizontal or vertical orientation of the article. The at least one angle indicator may be oriented at an indication angle relative to the at least one horizontal indicator corresponding to a desired inclination angle of the article. The at least one angle indicator may be arranged angularly to each side of the at least one horizontal indicator.

The casing may be substantially transparent. The cavity may be formed into a rear surface of the casing. The apparatus may further comprise a cap sized to enclose and seal the fluid in the cavity. The at least one angle indicators are arranged around a perimeter of the cavity.

The rear surface may be the mounting surface. The mounting surface may be securable to the article with adhesive. The article may comprise a ladder.

According to a further embodiment of the present disclosure is a method for indicating an angle of an article to a user comprising providing a casing secured to an article, the casing having a mounting surface adapted to be securable to an article, the casing having a cavity therein defining a cavity volume, the cavity having an axis extending normal to the mounting surface and a quantity of a fluid selected to have a volume equal to substantially 50 percent of the cavity volume contained within the cavity and orienting the article such that at least one angle indicator applied to an exterior surface of the casing around the cavity is aligned with a free surface of the fluid wherein the at least one angle indicator corresponds to a desired angle of the article.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a illustration of ladder having an apparatus for indicating the angle of the ladder thereon applied to a wall.

FIG. 2 is a perspective view of the apparatus of FIG. 1.

FIG. 3 is an exploded view of the apparatus of FIG. 1.

FIG. 4 is a front view of the apparatus of FIG. 1 at a target angle.

FIG. 5 is a cross-sectional view of the apparatus of FIG. 1 as taken along the line 4-4 in FIG. 2.

FIG. 6 is a perspective view of the apparatus of FIG. 1 according to a further embodiment.

### DETAILED DESCRIPTION

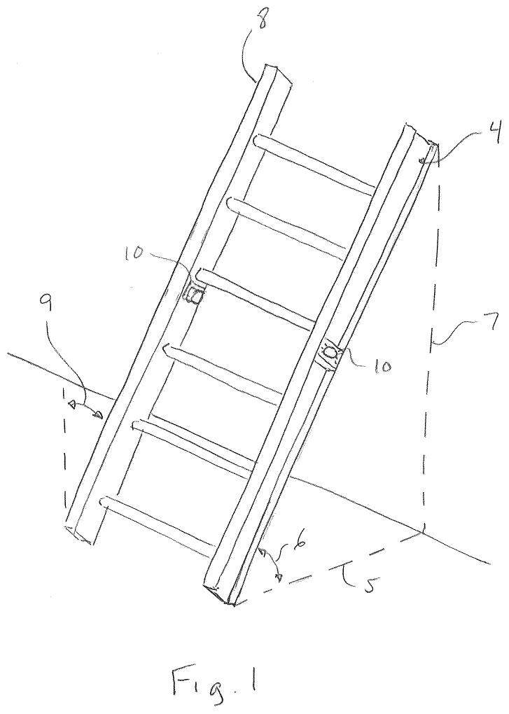

Referring to FIG. 1, an exemplary apparatus for indicating an angle of an article is illustrated generally at 10. As illustrated in FIG. 1, the apparatus 10 may be applied to a ladder 8 for indicating when the proper installation angle has been obtained although it will be appreciated that embodiments of the apparatus may also be utilized for indicating desired angles of other articles. As illustrated in FIG. 1, the apparatus 10 is configured to indicate when the desired angle 6 or relationship of the bottom distance 5 to height 7 is achieved. In particular the apparatus 10 may be secured to the ladder side rails so as to align the apparatus in the desired orientation relative to the ladder. As illustrated in FIG. 1, it will be appreciated that the apparatus 10 may be secured to either the inside or outside surface of a ladder railing.

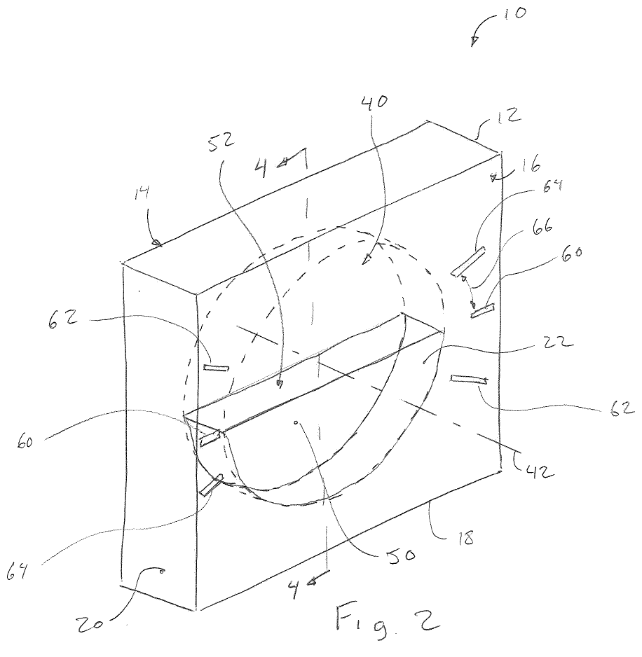

Turning now to FIG. 2, the apparatus 10 comprises a casing body 12, having a cavity 40 and a quantity of a liquid within the cavity. The casing body 12 includes at least one indicator positioned to align with an angular orientation of the casing body so as to indicate to a user when the casing body 12 and by extrapolation ladder 8 is oriented at the desired angle.

The casing body 12 is formed of a body extending between front and rear surfaces, 14 and 16, respectively and a perimeter edge 18. The perimeter edge may include at least one indexing surface 20 which is substantially flat so as to be operable to be positioned against a flat surface of the article to ensure proper alignment with the article. As illustrated in FIG. 2, the indexing surface 20 is to the left of the casing body and may be positioned to abut one of the flanges of the ladder rail 4 as illustrated in FIG. 1. It will be appreciated that other surfaces may also be utilized for such alignment including surfaces set at parallel, perpendicular or other angles relative to the horizontal or target angles as will be further set out below.

The cavity 40 comprises a contained void within the casing having a predetermined volume. As illustrated in FIGS. 1-4, the cavity 40 is substantially circular about an axis 42 extending therethrough which is normal to the front and rear surfaces 14 and 16. The casing 10 includes a front viewing window 22 covering and enclosing the cavity 40 while permitting viewing of the interior thereof. Other portions of the casing 12 may also be transparent for similar viewing from different angles.

The cavity 40 contains a quantity of a liquid 50 therein selected to have a volume approximately 50 percent of the volume of the cavity 40. Accordingly, it will be observed that as the casing 12 is rotated about the axis 42, a free surface 52 of the liquid 50 will remain at or near the axis 42. The liquid 50 may be selected to have a low freezing point to avoid freezing in cold environments and a high boiling point. The liquid may also be selected to have a low coefficient of thermal expansion to limit the effects of temperature change on the indicated angle. The liquid may optionally include a quantity of a coloring agent therein to enhance viewing of the free surface 52. By way of non limiting example, it has been found that mineral spirits have been useful although it will be appreciated that other liquids may also be utilized.

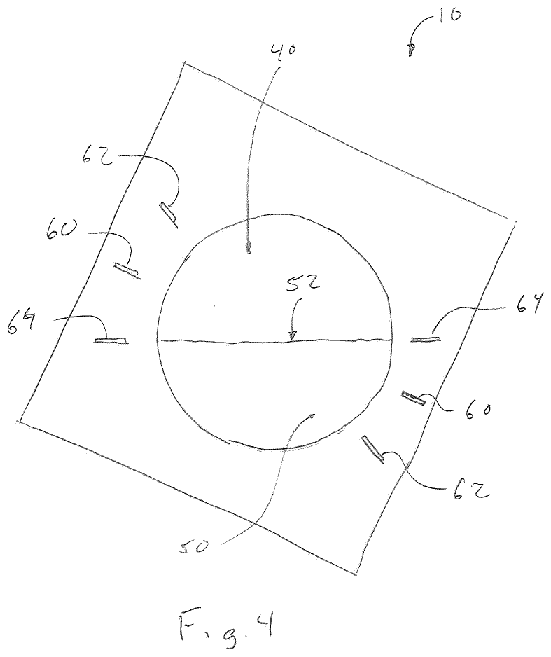

The casing 12 includes at least one angle indicator, 60, 62 or 64 positioned to indicate an angle of the free surface 52 of the liquid 50 when the casing 12 is oriented at a specific angle. In particular as illustrated in FIG. 2, the apparatus may include horizontal indicators 60 oriented about the axis 42 to indicate that the apparatus is horizontal when aligned with the free surface 52. Similarly, the indicators may comprise target indicators 62 and/or 64 oriented to indicate that the apparatus 10 is oriented at a desired angle. In particular, the target indicators may be angularly offset at a target angle, generally indicated at 66, from the horizontal indicators 60 or from horizontal. The target angle 66 may be selected to correspond to the angle of inclination, generally indicated at 9 in FIG. 1, such that when the ladder to which the apparatus 10 is applied is at the desired orientation, the free surface 52 of the liquid 50 will align with the target indicator as illustrated in FIG. 4.

As illustrated, the apparatus may include target indicators 62 and 64 to each angular side of the horizontal indicator 60 by the same angle or multiple angles may be utilized. Furthermore, a plurality of target indicators may be utilized to provide visual indication for one of a plurality of angles. It will be appreciated that utilizing the free surface of the liquid 50 contained within the cavity 40 will provide increased speed of use over conventional bubble levels and will also provide an indication of how far away from a desired angle the article is for ease of adjusting. Furthermore, the target indicators 62 and 64 may also be provided as a target range so as to indicate to a user an acceptable range of angles for the article.

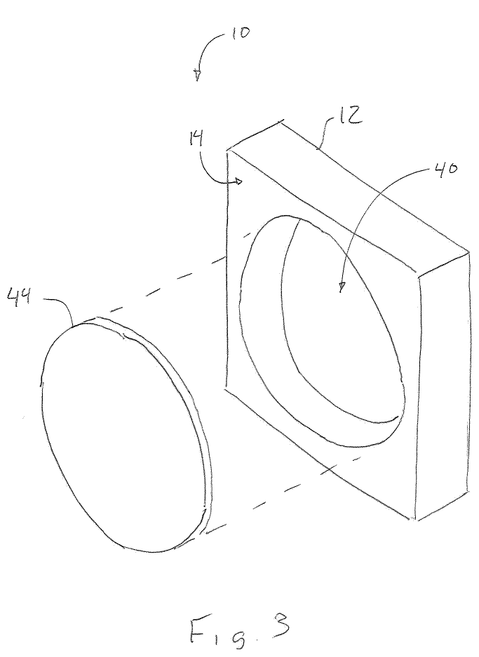

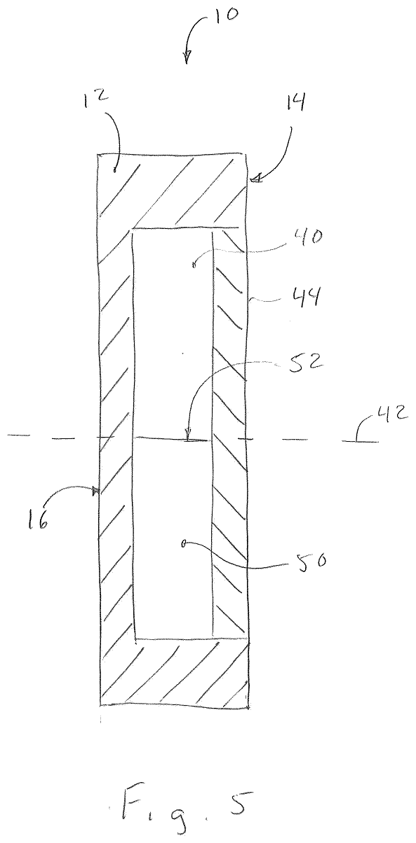

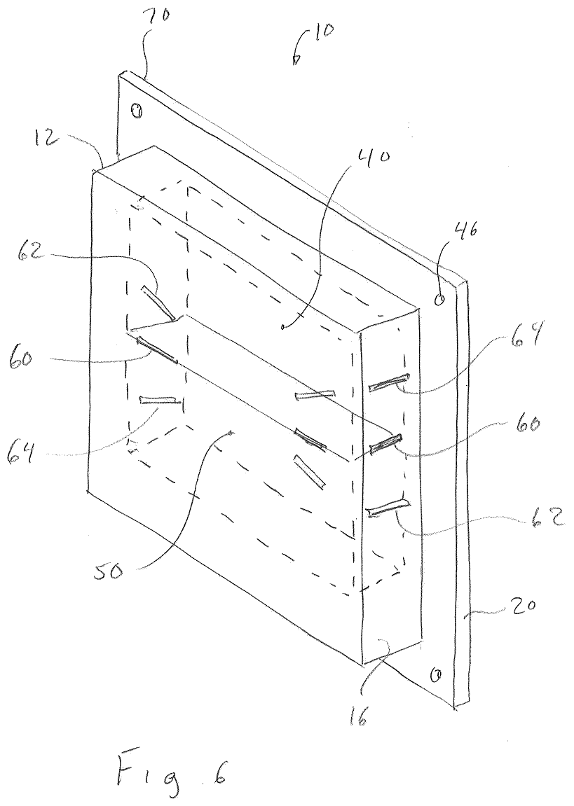

Turning now to FIG. 3, the casing body 12 may include the cavity 40 formed into the rear surface 14 thereof with a disc or plug 44 provided to seal the cavity and contain the liquid 50 therein as illustrated in FIG. 5. The rear surface 14 may also be adapted to be securable to the article through the use of adhesives (not shown) or fastener bores 46 as illustrated in FIG. 6. The cavity may have a width (between the plug 44 and viewing window 22) that is relatively narrow such that difference in liquid level front to back are minimized selected to minimize distortions of the fluid surface due to the meniscus or other effects. By way of non-limiting example, it has been found that a depth of between 2 and 5 mm ( 1/16 and 3/16 inch) has been useful for with mineral spirits. The cavity 40 may also have a diameter selected to provide adequate viewing and indication of the angle of the article to which it is applied. By way of non-limiting example, it has been found that a diameter of approximately 30 mm (1⅛ inch) on ladders, although it will be appreciated that other sizes may be useful for other viewing environments. It will also be appreciated that the dimensions of the cavity may be varied depending on the materials used to form the cavity as well as the selected fluid contained therein in so much as materials having a greater radius meniscus and wettability therebetween may be selected to have larger dimensions to reduce these effects whereas less wettable combinations with smaller radius meniscus may have smaller dimensions.

As illustrated in FIG. 6, other cross-sectional shapes for the cavity 40 may also be utilized including without limitation, square, rectangular or irregular provided the cross section is configured to permit the axis 42 to remain at the free surface of the liquid 50

The indicators 60, 62 and/or 64 may be provided to each side of the cavity 40 in opposed pairs as illustrated or may optionally be provided as a single indicator to one side thereof. Furthermore, as illustrated in FIG. 6, the indicators 60, 62 and or 64 may be applied to the viewing window 22 or around the perimeter 18 of the casing for viewing from different angles. Furthermore, the casing 12 may include a flange 70 or other structure extending outwardly from the casing so as to space the casing 12 and cavity 40 away from a surface to which the mounting surface 20 is applied.

While specific embodiments have been described and illustrated, such embodiments should be considered illustrative only and not as limiting the disclosure as construed in accordance with the accompanying claims.

What is claimed is:

1. An apparatus for indicating an angle of an article to a user comprising:
a casing having a mounting surface adapted to be securable to an article, the casing having a cavity therein defining a cavity volume, the cavity having an axis extending normal to the mounting surface;
a quantity of a fluid selected to have a volume equal to substantially 50 percent of the cavity volume contained within the cavity; and
at least one angle indicator applied to an exterior surface of the casing around the cavity, at a position selected to align with a free surface of the fluid when the article is arranged at a desired angle, the at least one angle indicator arranged annularly around the axis.

2. The apparatus of claim 1 wherein the casing includes a perimeter surface therearound perpendicular to the mounting surface.

3. The apparatus of claim 2 wherein the perimeter surface includes at least one indexing surface.

4. The apparatus of claim 3 wherein the indexing surface is selected to be one of parallel to or perpendicular to at least one horizontal indicator on the casing.

5. The apparatus of claim 1 wherein the at least one angle indicator are arranged in matched pairs on opposite sides of the axis of the cavity.

6. The apparatus of claim 1 wherein the at least one angle includes at least one horizontal indicator arranged at an angle adapted to correspond to one of a horizontal or vertical orientation of the article.

7. The apparatus of claim 6 wherein the at least one angle indicator is oriented at an indication angle relative to the at least one horizontal indicator corresponding to a desired inclination angle of the article.

8. The apparatus of claim 7 wherein the at least one angle indicator is arranged angularly to each side of the at least one horizontal indicator.

9. The apparatus of claim 1 wherein the casing is substantially transparent.

10. The apparatus of claim 1 wherein the cavity is formed into a rear surface of the casing.

11. The apparatus of claim 10 further comprising a cap sized to enclose and seal the fluid in the cavity.

12. The apparatus of claim 1 wherein the at least one angle indicators are arranged around a perimeter of the cavity.

13. The apparatus of claim 1 wherein the rear surface is the mounting surface.

14. The apparatus of claim 13 wherein the mounting surface is securable to the article with adhesive.

15. The apparatus of claim 1 wherein the article comprises a ladder.

16. A method for indicating an angle of an article to a user comprising:
providing a casing secured to an article, the casing having a mounting surface adapted to be securable to an article, the casing having a cavity therein defining a cavity volume, the cavity having an axis extending normal to the mounting surface and a quantity of a fluid selected to have a volume equal to substantially 50 percent of the cavity volume contained within the cavity; and
orienting the article such that at least one angle indicator applied to an exterior surface of the casing around the cavity is aligned with a free surface of the fluid,
wherein the at least one angle indicator corresponds to a desired angle of the article.
